(19) United States
(12) Patent Application Publication
(10) Pub. No.: US 2004/0239196 A1
(43) Pub. Date: Dec. 2, 2004

(54) Motor with a brake

(76) Inventors: Hiromasa Miura, Nagano-ken (JP); Toshiyuki Noda, Nagano-ken (JP)

Correspondence Address: WENDEROTH, LIND & PONACK, L.L.P., 2033 K STREET N. W., SUITE 800, WASHINGTON, DC, 20006-1021, US

(21) Appl. No.: 10/788,355

(22) Filed: Mar. 1, 2004

(30) Foreign Application Priority Data
May 7, 2003 (JP) 2003-129158

(51) Int. Cl. H02K 7/10; B60T 8/40; H02P 3/00

(52) U.S. Cl. 310/77; 318/372

(57) ABSTRACT

The present invention provides a motor with a brake in which, after an initial stage, a voltage applied to the brake is reduced to thereby restrain heat generation in the brake. In the motor with a brake, after signal drive, a voltage of a drive signal supplied to an electromagnetic drive portion of the brake is reduced, whereby heat generation in the brake during motor rotation is restrained, which makes it possible to increase a load to be applied to the motor.

### BACKGROUND OF THE INVENTION

1. Field of the Invention

The present invention relates to a motor with a brake. In particular, the present invention relates to a novel improvement of a motor with a brake for restraining heat generation in a coil of an electromagnetic drive portion of the brake. The restrain of heat generation can be attained such that a normal voltage is applied during initial excitation for brake releasing with a motor drive power on and in which, after initial excitation, a lower voltage is applied for excitation.

2. Description of the Related Art

In a conventional motor with a brake of this type, the electromagnetic drive portion is on when the motor is on to keep the brake electromagnetically released. When the motor is turned off, the brake is engaged by a spring, preventing rotation of the rotor by the brake (see, for example, JP 2000-50569 A).

The conventional motor with a brake is constructed as described above, and therefore has the following problems.

That is, the brake of the motor with a brake is constructed as mentioned hereinbelow. When the motor is off, no voltage is being applied to the brake, and a movable brake plate is urged by a spring to abut a stationary brake plate, thereby providing a braking action. When the motor is turned on, the brake is simultaneously excited, and the movable brake plate is pulled against a resilient force of the spring to release the brake. Thus, when the motor is on, high voltage is constantly applied to the brake.

Thus, when the motor is driven for a long period of time, voltage of an initial level continues to be applied to the brake all the while, and the brake generates heat, which is transmitted to the stator side, making it difficult to apply excessive load not only to the brake but also to the motor itself.

Further, generally speaking, the brake drive voltage, which depends on the brake used, differs from the voltage of the motor drive power source, so that it is necessary to provide a brake drive power source dedicated to brake driving.

### SUMMARY OF THE INVENTION

The present invention has been made with a view toward solving the above problems in the prior art. An object of the present invention is, in particular, to provide a motor with a built-in drive circuit having a brake in which a normal voltage is applied during initial excitation for brake releasing with a motor drive power on and in which, after initial excitation, a lower voltage is applied for excitation to thereby restrain heat generation in a coil of an electromagnetic drive portion of the brake, and a motor drive power source is also used for brake driving, thus eliminating a dedicated power source for the brake.

A motor with a brake according to the present invention includes: a stator provided in a cylindrical case and having a stator coil; a rotation shaft rotatably supported by bearings at both ends of the cylindrical case and having a rotor; an electromagnetic drive portion having a movable brake plate for stopping rotation of the rotor; a stationary brake plate fixed to a side of the rotor; and a spring for urging the movable brake plate toward the stationary brake plate, a braking action being applied to the rotor by the spring when power is off, and the electromagnetic drive portion being excited at a time of driving to separate the movable brake plate from the stationary brake plate to allow the rotor to rotate, in which, after initial excitation of the electromagnetic drive portion to separate the movable brake plate from the stationary brake plate, the voltage supplied to the electromagnetic drive portion is reduced to a level lower than that of the initial excitation voltage for the initial excitation. Also, in the motor with a brake, the voltage for driving the electromagnetic drive portion is controlled by means of a PWM pulse signal.

### BRIEF DESCRIPTION OF THE DRAWINGS

In the accompanying drawings:

FIG. 1 is a sectional view of a motor with a brake according the present invention;

FIG. 2 is a schematic diagram showing how the motor of FIG. 1 functions;

FIG. 3 is a block diagram showing the drive system for the brake shown in FIG. 1; and

FIG. 4 is a block diagram showing another embodiment of FIG. 3.

### DETAILED DESCRIPTION OF PREFERRED EMBODIMENT

A motor with a brake according to a preferred embodiment of the present invention is hereinafter described with reference to the drawings.

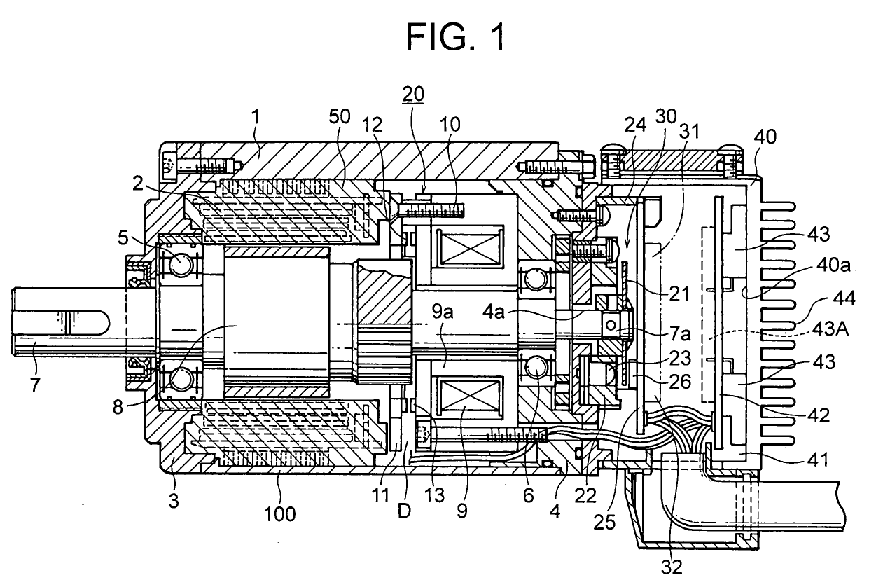

In FIG. 1, numeral 1 indicates a cylindrical case having a stator 3 around which a stator coil 2 is wound. A front cover 3A and a rear cover 4 are mounted respectively to the ends of the cylindrical case 1.

A rotation shaft 7 is rotatably supported by bearings 5 and 6 provided in the front cover 3A and the rear cover 4, respectively. A rotor 8 situated inside the stator 3 is rotatably provided on the rotation shaft 7, and the rear cover 4 is equipped with an electromagnetic drive portion 9 having an excitation coil (not shown). The stator 3, the rotor 8, and an encoder 30 constitute a servo motor portion 100.

A stationary plate 11 is secured to a position on the front cover 3A side of the electromagnetic drive portion 9 through the intermediation of a bolt 10 so as to maintain a gap D therebetween.

Arranged inside the gap D are a stationary brake plate 12 and a movable brake plate 13. The stationary brake plate 12 is fixed to the rotor 8 side, and the movable brake plate 13 is axially movable with respect to the electromagnetic drive portion 9 through the intermediation of a spring (not shown).

As is well known in the art, this spring is provided, in a compressed state, inside a casing 9a of the electromagnetic drive portion 9. This spring causes the movable brake plate 13 to be held in contact with the stationary brake plate 12.

Thus, when the electromagnetic drive portion 9 is not being excited, the movable brake plate 13 is held in contact with the stationary brake plate 12 to prevent rotation of the rotor 8. When the electromagnetic drive portion 9 is excited, the movable brake plate 13 is attracted to release the stationary brake plate 12, thereby enabling the rotor 8 to rotate.

The stationary brake plate 11, the movable brake plate 13, and the electromagnetic drive portion 9 constitute a well-known brake 20.

The electromagnetic drive portion 9 is excited through application of a drive signal 200 having a predetermined voltage.

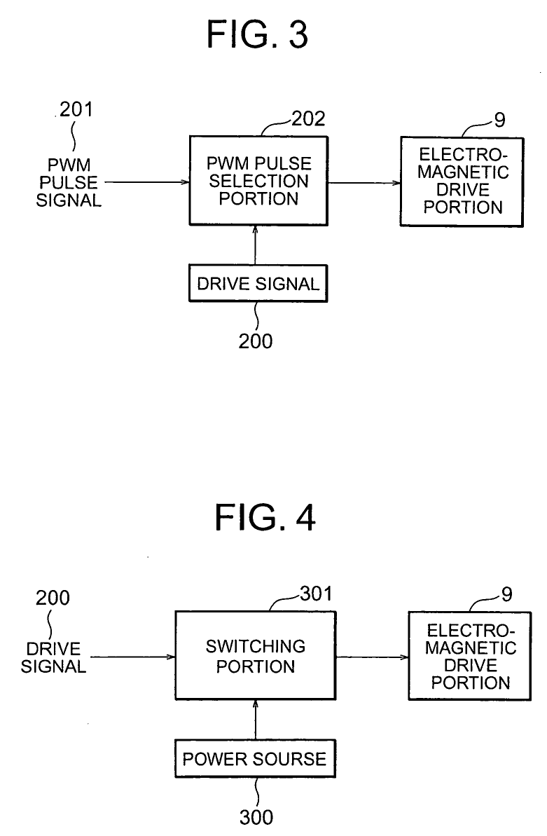

In the case of FIG. 3, the drive signal 200 of a predetermined voltage is variably selected by a well-known PWM (pulse width modulation) type pulse signal 201 (as disclosed, for example, in JP 6-284781 A and JP 6-165573 A) at a PWM-pulse-signal-selection portion 202, and is applied to the electromagnetic drive portion 9.

That is, exclusively when the motor power is on, the drive signal 200 of a predetermined voltage (e.g., 10V) is applied to the electromagnetic drive portion 9 for initial excitation, so that the movable brake plate 13 is separated from the stationary brake plate 12 to thereby release the brake 20.

The initial excitation voltage applied at the time of initial excitation is the same as that of the drive signal 200. Once the brake 20 has been released, the voltage level of the drive signal 200 is reduced to a voltage level lower than that for the initial excitation (e.g., 5V or less) at the selection portion 202 by the PWM pulse signal 201 with a pre-set timing. Accordingly, switching is effected to a minimum voltage level allowing the brake 20 to continue to remain in the released state. While the motor is being driven, the heat generation in the coil (not shown) of the electromagnetic drive portion 9 is minimum.

Apart from the above-described method using the PWM pulse signal 201, it is also possible to adopt a method as shown in FIG. 4, in which the drive signal 200 is input to a switching portion 301 connected to a power source 300 and in which only at the time of initial excitation, the voltage of the drive signal 200 is input as it is to the electromagnetic drive portion 9; after the brake 20 has been released, the drive signal 200 with its voltage level lowered at the switching portion 301 is input to the electromagnetic drive portion 9 to restrain heat generation during motor drive,

The method of switching the voltage of the drive signal 200 to be applied to the electromagnetic drive portion 9 is not restricted to those as described with reference to FIGS. 3 and 4. It is also possible to adopt a method using some other means such as a timer.

Further, the same power source is used for brake driving and motor driving. Even when the voltage of the motor drive power source is higher than the initial excitation voltage for the brake 20, it is possible to apply an appropriate brake drive voltage to the brake 20 by using the above-mentioned PWM pulse signal 201.

The protruding portion 7a of the rotation shaft 7 passed through and extending beyond the opening 4a of the rear cover 4 is equipped with a code plate 21, and a retaining plate 22 provided in the rear cover 4 is equipped with a light emitting member 23.

Provided on the rear cover 4 through the intermediation of a support member 24 is a sensor circuit board 25 composed of a printed circuit board, which is secured in position on the outer side, that is, on the rear side of the code plate 21 mentioned above.

On one surface of the sensor circuit board 25, there is provided a light receiving member 26. The light emitting member 23, the code plate 21, and the light receiving member 26 constitute an encoder 30 as a rotation detector. It is also possible to use a well-known resolver instead of this encoder.

On the other surface of the sensor circuit board 25, there are provided a sensor circuit portion 31 and a drive control circuit portion 32, which are well-known and composed of ICs. The sensor circuit portion 31 performs power and signal processing with respect to the encoder 30 to supply an encoder signal to the drive control circuit portion 32.

A cup-shaped sensor cover 40 formed of a material having a satisfactory heat radiation property, such as aluminum, is mounted to the rear side of the rear cover 4 so as to cover the encoder 30.

The sensor cover 40 has on its inner surface a holder 41, to which a motor drive board 42 composed of the printed circuit board is mounted. The motor drive board 42 has a power device 43 composed of a power transistor or the like, which is held in contact with and joined to the inner surface 40a of the sensor cover 40, making it possible to effect heat transmission and heat radiation.

The sensor cover 40 has on its surface cooling fins 44, by means of which heat radiation can be effected with high efficiency.

As is well known in the art, the motor drive board 42 is equipped with a motor drive circuit 43A for driving the three-phase stator winding 2 by the power device 43, and the drive control circuit portion 32 performs drive control on the motor drive circuit 43A.

An outer diameter of the sensor circuit board 25 and that of the motor drive board 42 are smaller than an inner diameter of the sensor cover 40 and an outer diameter of the servo motor portion 100. The sensor circuit board 25 and the motor drive board 42 are arranged side by side inside the sensor cover 40 so as to be spaced apart from each other in an axial direction thereof.

The sensor circuit portion 31, the drive control circuit portion 32, and the motor drive circuit 43A constitute circuits which are electrically independent of each other, and no electrical isolation circuit as in the prior art is used.

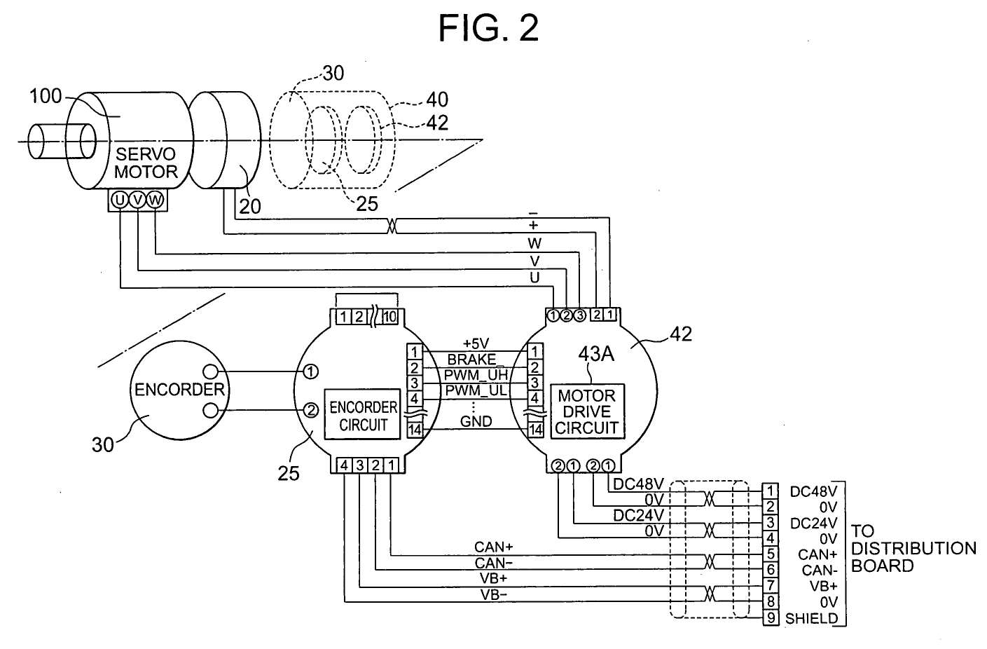

The above-described boards 25 and 42 of FIG. 1 are constructed as schematically shown in FIG. 2, which shows the electrical connection relationship thereof.

Next, an operation of this embodiment will be described. First, in the above-described construction, upon turning on the power, the electromagnetic drive portion 9 is simultaneously operated to attract the movable brake plate 13 to release the brake 20, and the servo motor portion 100 starts rotation on the basis of a position signal (mutual switching signal) from the encoder 30. Thereafter, the servo drive of the servo motor portion 100 is started on the basis of a command signal (not shown) from outside and an encoder signal from the encoder 30. At the same time, the motor drive is continued while keeping the brake 20 in the released state through the application of the above-mentioned minimum voltage.

Note that the present invention is applicable not only to the servo motor but also to an ordinary motor.

The motor with a brake of the present invention, constructed as described above, provides the following advantages.

That is, instead of constantly applying the voltage of the same level to the electromagnetic drive portion of the brake, the following arrangement is adopted: at the time of initial excitation, that is, when the power is turned on, the drive signal at the ordinary voltage level is applied. Thereafter, the drive signal reduced to a voltage level barely allowing the movable brake plate to be attracted and keeping the brake in the released state is used. Thus, even when the motor is driven for a long period of time, it is possible to restrain heat generation in the coil of the electromagnetic drive portion and to restrain heat generation in the motor, making it possible to apply a large load to the motor.

Further, it is possible to control the brake drive voltage by the PWM signal, so that the motor drive power source can also be used as the brake drive power source.

What is claimed is:

1. A motor with a brake, comprising: a stator provided in a cylindrical case and having a stator coil; a rotation shaft rotatably supported by bearings at both ends of the cylindrical case and having a rotor; an electromagnetic drive portion having a movable brake plate for stopping rotation of the rotor; a stationary brake plate fixed to a side of the rotor; and a spring for urging the movable brake plate toward the stationary brake plate, a braking action being applied to the rotor by the spring when power is off, and the electromagnetic drive portion being excited at a time of driving to separate the movable brake plate from the stationary brake plate to allow the rotor to rotate,
wherein after initial excitation of the electromagnetic drive portion to separate the movable brake plate from the stationary brake plate, the voltage supplied to the electromagnetic drive portion is reduced to a level lower than that of the initial excitation voltage for the initial excitation.

2. A motor with a brake according to claim 1, wherein the voltage for driving the electromagnetic drive portion is controlled by means of a PWM pulse signal.
